(19) United States
(12) Patent Application Publication
(10) Pub. No.: US 2026/0176079 A1
(43) Pub. Date: Jun. 25, 2026

(54) CONVEYOR TAKE-UP DEVICE

(71) Applicant: Herzog Railroad Services, Inc., St. Joseph, MO (US)

(72) Inventors: Matthew L. Combs, Agency, MO (US); Colton Lee, Gower, MO (US)

(73) Assignee: Herzog Railroad Services, Inc., St. Joseph, MO (US)

(21) Appl. No.: 19/427,484

(22) Filed: Dec. 19, 2025

Related U.S. Application Data
(60) Provisional application No. 63/737,025, filed on Dec. 20, 2024.

(51) Int. Cl. B65G 23/00

(52) U.S. Cl. CPC B65G 23/00

(57) ABSTRACT

A conveyor take-up device for adjusting tension in a conveyor belt is disclosed. The device includes a linear actuator extending between a conveyor frame and a roller bracket securable to a head roller of the conveyor. The linear actuator includes a rotary drive mechanism having a drive head mounted at a drive end and operable to extend and retract a drive screw disposed within at least one tube. The roller bracket extends proximate the drive head and defines an access space into which the drive head extends to permit tool engagement. Rotation of the drive head repositions the head roller relative to the conveyor frame to adjust belt tension.

### CROSS-REFERENCE TO RELATED APPLICATIONS

This application claims the benefit of U.S. Provisional Patent Application No. 63/737,025, filed Dec. 20, 2024, the disclosure of which is hereby incorporated herein in its entirety by reference.

### FIELD OF THE INVENTION

This invention relates to conveyor systems, and in particular to a conveyor take-up device for maintaining tension in a conveyor belt during operation.

### BACKGROUND

Conveyor systems are widely used to move materials from one location to another. In many conveyor systems, materials travel along a continuous belt tensioned across and around multiple pulleys. The belt stretches and deforms over time, resulting in undesirable slippage, sagging, and other issues that may impact operation of a conveyor system. To avoid such issues, many conveyor systems are equipped with take-up devices for continually maintaining tension in the belt.

Various types of take-up devices are well-known. Commonly, one or more extendable and retractable take-up devices are secured to a movable pulley and are operated to extend or retract the pulley and calibrate the tension in the belt by taking up or releasing slack in the belt as needed. Extension and retraction of such devices is often enabled by a screw-driven linear actuator furnished with a linear adjustment feature on its rear or cap end. Adjustment of the feature drives the screw inward or outward and selectively extends or retracts the pulley to tension the belt. A problem with take-up devices utilizing cap end adjustment features is that they require maintenance technicians and other operators to reach around the take-up device to extend or retract the pulley. But reaching around the take-up device is often labor-intensive and involves accessing elevated areas or other dangerous spaces. What is needed is a take-up device having an adjustment feature that can be accessed without reaching around the take-up device.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes, among other things, a take-up device for adjusting and maintaining tension in a conveyor belt, and conveyor systems and methods employing such a take-up device.

In one aspect, the take-up device includes a linear actuator having a rotary drive mechanism and a drive head mounted at a drive end of the linear actuator. A roller bracket is secured to the linear actuator and extends proximate the drive head, with rotation of the drive head causing extension and retraction of the linear actuator. In another aspect, the disclosure provides a conveyor take-up device configured for installation on a conveyor. The conveyor take-up device includes a roller bracket securable to a head roller of the conveyor and a linear actuator extending between a frame of the conveyor and the roller bracket. The linear actuator may include a drive screw disposed within at least one tube, such as telescoping inner and outer tubes, with a drive head mounted at a drive end of the linear actuator and operable to extend and retract the drive screw. An access space is formed within the roller bracket, and the drive head extends into the access space to permit engagement by an adjustment tool while the take-up device remains installed on the conveyor.

In certain embodiments, the roller bracket includes a yoke and a bearing mount secured to each other and cooperating to define the access space. The yoke may include a cross-bar positioned proximate the drive end of the linear actuator and first and second prongs extending from the cross-bar and spaced apart from each other, with the access space extending therebetween. A thrust washer may be provided between the rotary drive mechanism and the roller bracket to reduce friction during extension and retraction of the linear actuator. The roller bracket may further include a backing plate for structural reinforcement, and the bearing mount may include an offset portion reinforced by one or more gusset plates, with an access opening formed in the bearing mount to facilitate use of an adjustment tool.

In further embodiments, the conveyor take-up device includes visual indication features for monitoring adjustment of the take-up device. An indicator plate having an indicating slit may be secured to the linear actuator, and a slide ruler may be secured to the roller bracket and extend a distance corresponding to a stroke length of the linear actuator. The slide ruler may include a plurality of hash marks oriented such that a selected hash mark is visible through the indicating slit to provide a visual indication of actuator extension and head roller position.

In still another aspect, the disclosure provides a method of maintaining tension of a conveyor belt using a conveyor take-up device. The method includes securing a roller bracket to a bearing supporting a head roller of a conveyor, securing a linear actuator to a frame of the conveyor, advancing an adjustment tool into an access space formed in the roller bracket, and rotating a drive head to translate a drive screw of the linear actuator and reposition the head roller relative to the conveyor frame. The method may be repeated to re-tension the conveyor belt as the belt elongates during use.

### DESCRIPTION OF THE DRAWINGS

Illustrative embodiments of the invention are described in detail below with reference to the attached drawing Figures, and wherein:

FIG. 1 is a front perspective view of a conveyor equipped with take-up devices in accordance with an embodiment of the invention viewed from above and to the left;

FIG. 2 is a front perspective view of the take-up device of FIG. 1 in a retracted position, viewed from above and to the right;

FIG. 3 is a rear perspective view of the take-up device of FIG. 1 in a retracted position, viewed from below and to the left;

FIG. 4 is a side elevational view of the take-up device of FIG. 1 in a retracted position, viewed from the right and depicted with an inner tube and an outer tube removed for clarity;

FIG. 5 is a side elevational section view of the take-up device of FIG. 1 in a retracted position, viewed from the right and taken in a central longitudinal plane of the take-up device;

FIG. 6 is a front perspective view of the take-up device of FIG. 1 in an extended position, viewed from above and to the right;

FIG. 7 is a rear perspective view of the take-up device of FIG. 1 in an extended position, viewed from below and to the left;

FIG. 8 is a side elevational section view of the take-up device of FIG. 1 in an extended position, viewed from the right and taken in a central longitudinal plane of the take-up device;

FIG. 9 is a front perspective view of the take-up device of FIG. 1 in a retracted position, viewed from above and to the left and depicted with a bracket and a drive head removed for clarity;

FIG. 10 is a rear perspective view of a bracket of the take-up device of FIG. 1, viewed from below and to the left;

FIG. 11 is a front perspective view of an alternative embodiment of the take-up device in a retracted position, viewed from above and to the right;

FIG. 12 is a rear perspective view of the take-up device of FIG. 11 in a retracted position, viewed from above and to the right;

FIG. 13 is a front perspective view of the take-up device of FIG. 11 in an extended position, viewed from above and to the right.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

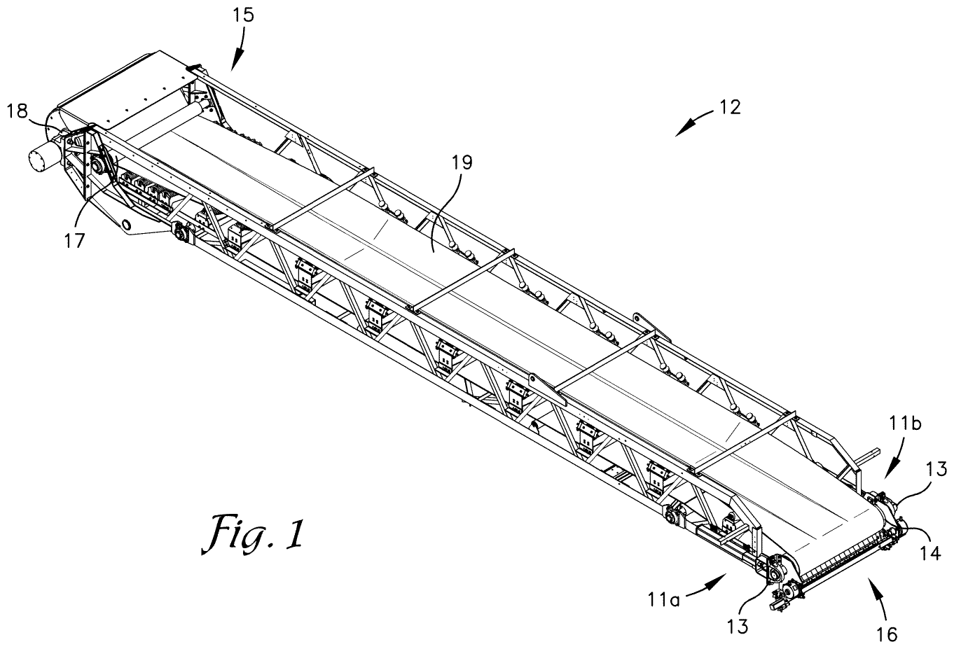

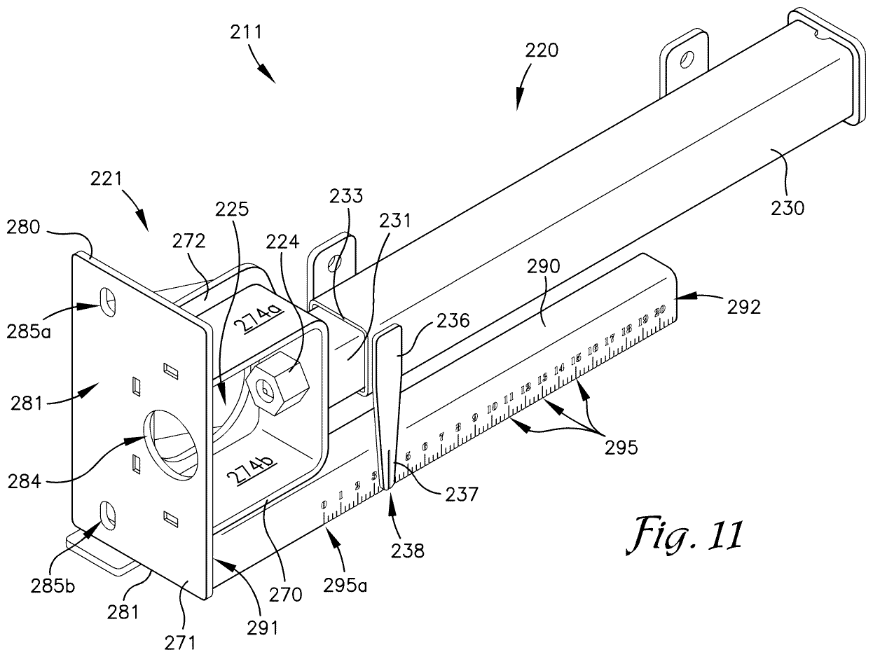

As used herein, directional references may be used with reference to the orientation of the conveyor to which the inventive take-up device is configured to be secured. With reference to FIGS. 1 and 11, the words “front” or “forward” refer to the right of the page and the words “rear” or “rearward” refer to the left of the page. The words “upwardly,” “upper,” “above,” “downwardly,” “lower,” “below,” “right,” and “left” will refer to directions in the drawings to which reference is made. The terms “about” or “approximately” as used herein denote deviations from the exact value by +/−10%, preferably by +/−5%, and/or deviations in the form of changes that are insignificant to the described function. Said terminology will include the words specifically mentioned, derivatives thereof, and words of a similar import.

Referring to the drawings in more detail, the reference number 11 generally designates a take-up device or conveyor tensioner according to the present invention. Referring to FIG. 1, a pair of take-up devices 11a and 11b are shown secured to opposite sides of a conveyor 12, with each take-up device 11 secured to a respective pillow block bearing 13 and adjustable to extend or retract a head roller 14 relative to an end of the conveyor 12. The take-up devices 11 are particularly well-adapted for use with offloading conveyors, such as offloading conveyors which may be used for depositing ballast or other materials from an offloading car in desired locations alongside or ahead of a consist, such as the offloading conveyor described in U.S. Pat. No. 9,346,473 assigned to Herzog Railroad Services, Inc. of St. Joseph, MO, but it is foreseen that the take-up devices 11, which may be referred to as first and second take-up devices 11a and 11b, may be used with virtually any other type of belt conveyor. The conveyor 12 extends from an intake end 15 to a discharge end 16, with a tensioning roller 17 and a drive roller 18 situated proximate the intake end 15 and the head roller 14 situated proximate the discharge end 16. A conveyor belt 19 for transporting materials along the conveyor 12 is routed around the head roller 14 and drive roller 18 and under the tensioning roller 17 along feed and return runs, and the conveyor 12 is preferably a trough-style conveyor in which rollers are provided between the feed and return runs of the belt 19 to support the feed run of the belt 19 in a generally U-shaped configuration.

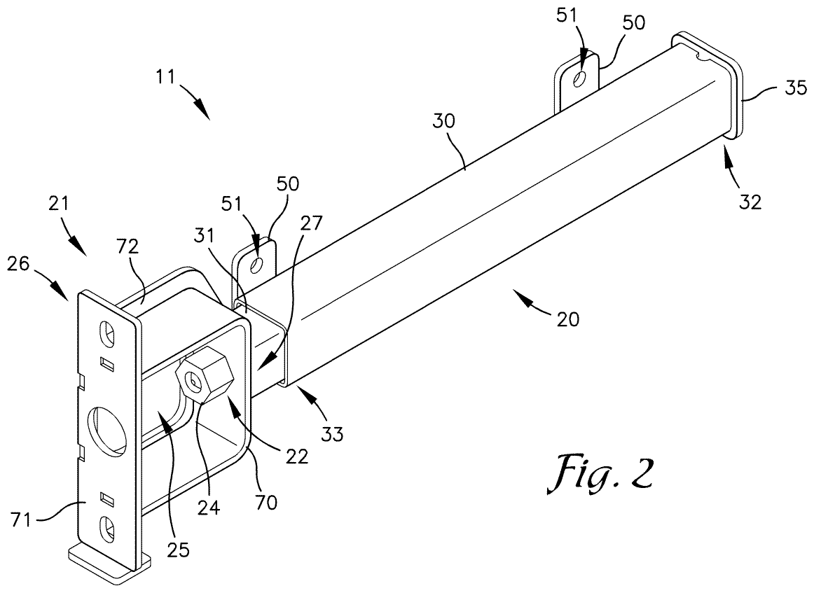

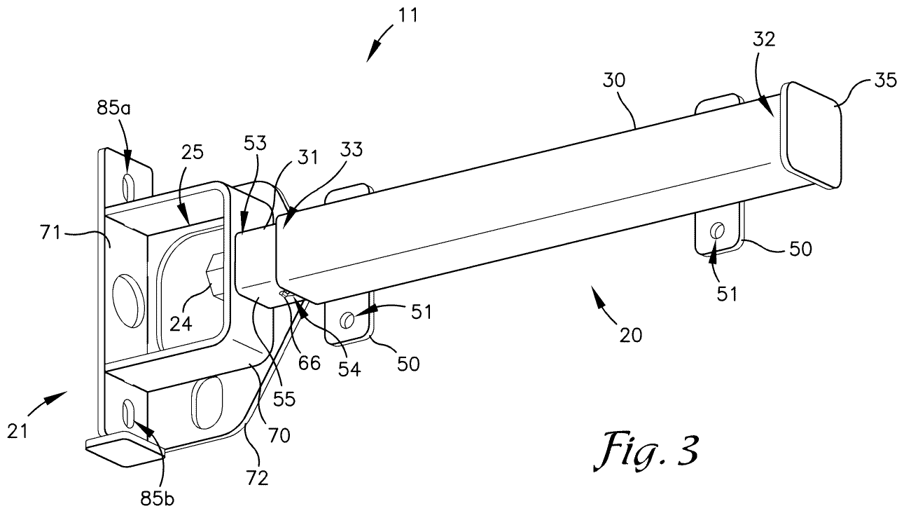

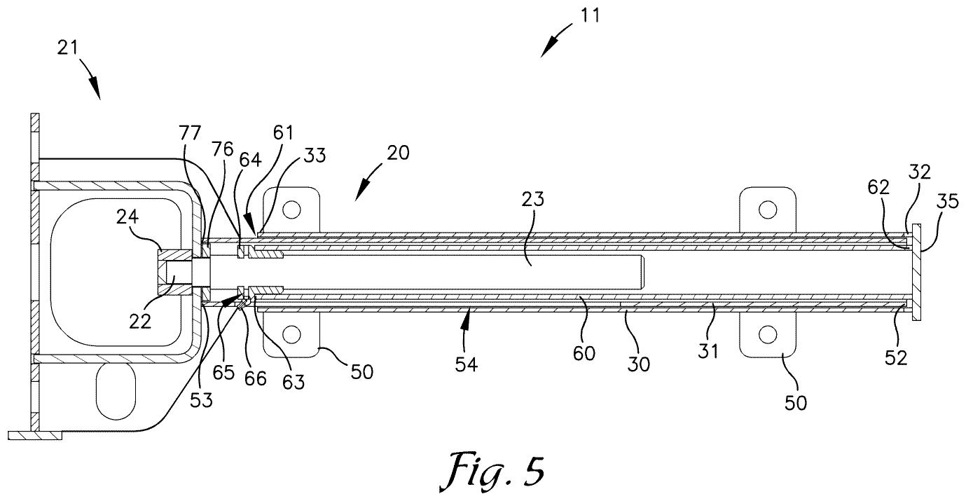

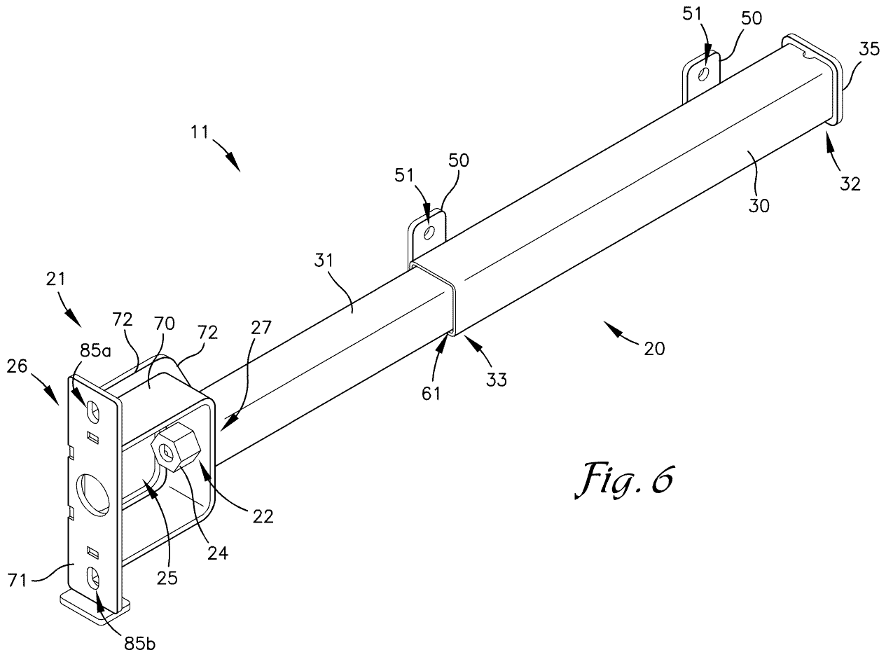

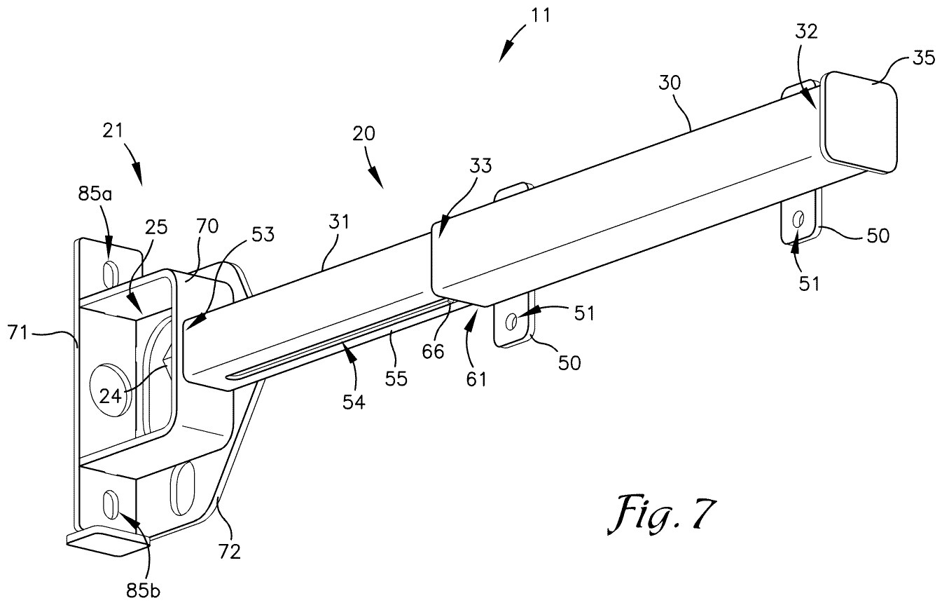

Referring now to FIGS. 1-10, the take-up device 11 is shown in greater detail. The take-up device 11 includes a linear actuator 20 and a roller bracket 21 or bearing support bracket 21, with the roller bracket 21 extending proximate a bracket or drive end 22 of the linear actuator 20. As best seen in FIG. 5, the linear actuator 20 comprises a rotary drive mechanism 23 and a drive feature or drive head 24 rotatably mounted thereto, with the drive head 24 extending from the drive end 22 of the linear actuator 20 through the roller bracket 21 and into an access space 25 formed therein. The access space 25 is sized to receive or accept an adjustment tool, such as a wrench, for rotating the drive head 24 to drive the linear actuator 20 for advancing the take-up device 11 between a retracted position (see FIG. 2) and an extended position (see FIG. 6). The roller bracket 21 extends between an outer or block end 26 and an inner or drive end 27, with the outer end 26 secured to the pillow block bearing 13 for supporting an end of a shaft of the conveyor head roller 14, and the inner end 27 secured to the drive end 22 of the linear actuator 20. The roller bracket 21 interconnects the pillow block bearing 13, and the shaft of the head roller 14 supported thereby, to the linear actuator 20, enabling adjustment of the position of the head roller 14 to maintain sufficient tension in the belt 19 as the drive head 24 is rotated to advance the take-up device 11 between the retracted position and the extended position.

Each linear actuator 20 comprises a first or outer tube 30 and a second or inner tube 31, with the inner tube 31 nested within and extending in relatively closely spaced relation to the outer tube 30 such that the inner tube 31 is retractable into and extendable out of the outer tube 30 in telescoping fashion upon rotation of the drive head 24 to extend and retract the linear actuator 20. The outer tube extends from a rear end 32 to a front end 33, with a cap 35 secured to the rear end 32, and the front end 33 open to allow the inner tube 31 to slide into and out of the outer tube 30. One or more mounting plates 50 are secured to an inner wall of the outer tube 30, each of which includes one or more fastener receiving features 51 that are alignable with corresponding features formed on the frame of the conveyor 12 and are adapted to receive a fastener (not shown), such as a screw, bolt, or the like, for mounting the actuator 20 to a side of the conveyor 12.

The inner tube 31 extends from a rear end 52 to a front end 53 which abuts against the roller bracket 21, with the inner tube 31 extending a length sufficient for a rear end 52 to be nested within and shielded by the outer tube 30 when the linear actuator 20 is extended (see FIGS. 6-8). A generally elongate zerk slot 54 is formed in a downward-facing wall 55 of the inner tube 31, with the length of the zerk slot 54 corresponding to the stroke length of the linear actuator 20 and/or the maximum linear distance that the inner tube 31 slides as the linear actuator 20 extends and retracts to drive the take-up device 11 between the retracted position and the extended position.

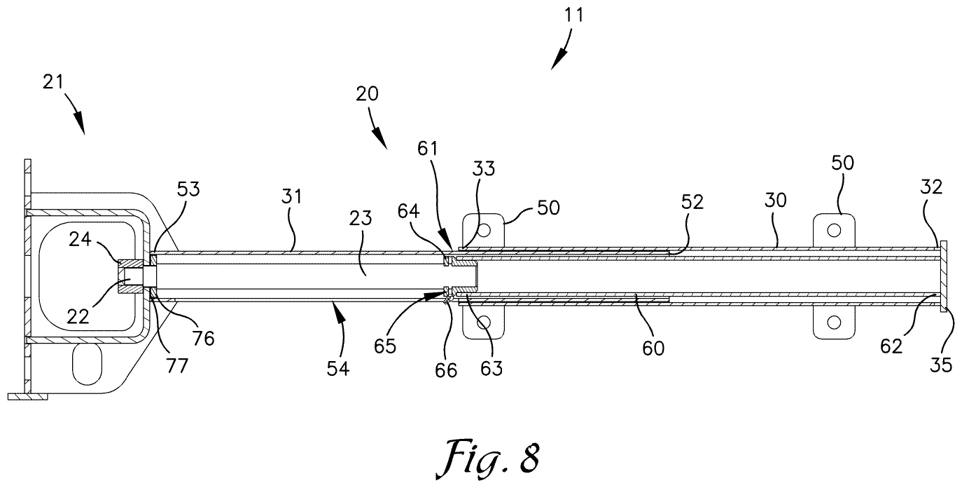

As best seen in FIGS. 5 and 8, the linear actuator 20 includes a screw housing or screw receiving cylinder 60 which extends within the outer and inner tubes 30 and 31. The outer tube 30 is spaced outward from the screw housing 60 such that a circumferential gap 61 is formed therebetween, with the inner tube 31 traveling within the circumferential gap 61 upon extension and retraction of the linear actuator 20. The screw housing 60 extends from a rear end 62 to a front end 63, with the rear end 62 attached to the cap 35 and the front end 63 extending in approximately the same plane as the open front end 33 of the outer tube 30. A threaded nut 64 is secured to the front end 63 of the screw housing 60, with the rotary drive mechanism 23, which is a drive screw 23 in the embodiment shown, threadingly coupled to and extending through the threaded nut 64 and into the screw housing 60. Cooperation of the drive screw 23 and the threaded nut 64 allows the drive screw 23 to translate linearly forward or rearward relative to the threaded nut 64 as the drive screw 23 is rotated in one or direction or the other via the drive head 24. A downward-facing zerk port 65 which is formed in the threaded nut 64 receives a zerk 66 through which lubricant, such as oil or grease, is applied to the threads formed in the nut 64 and the threads formed on the drive screw 23. The zerk 66 extends downwardly through the zerk slot 54, such that the inner tube 31 does not contact or interfere with the zerk 66 as the linear actuator 20 extends and retracts to drive the take-up device 11 between the retracted position and the extended position.

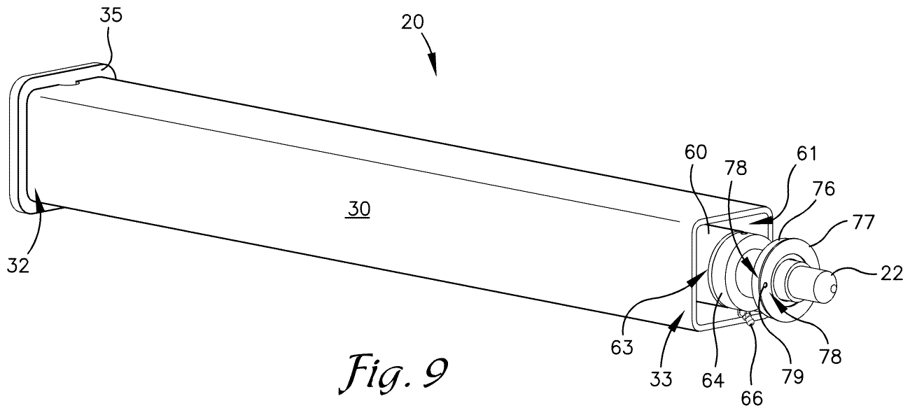

The roller bracket 21 extends between the actuator 20 and the pillow block bearing 13 and includes a yoke 70, a bearing mount 71, and a backing plate 72 which are connected to each other and cooperate to define the access space 25. The yoke 70 includes a cross-bar 73, which may be referred to as an actuator mounting feature 73, with first and second prongs 74a and 74b extending forward from opposite ends of the cross-bar 73. The first and second prongs 74a and 74b, which may be referred to as upper and lower prongs 74a and 74b, are oriented in spaced apart relation from each other such that the upper prong 74a extends above the access space 25 and the lower prong 74b extends below the access space 25. The front end 53 of the inner tube 31 abuts against, or may be connected to, a rear face of the cross-bar 73, with the drive end 22 of the drive screw 23 extending through a shaft opening 75 formed in the cross-bar 73 and into the access space 25. As best shown in FIGS. 5 and 9, a collar 76 and a thrust washer 77 circumscribe the drive screw 23 and are situated just rearward of the cross-bar 73. The thrust washer 77 extends between and abuts or fits snugly against the collar 76 and the cross-bar 73, with the collar 76 and the thrust washer 77 including respective pin-receiving holes 78 which are axially alignable with each other and are configured to receive a pin 79 to maintain alignment of the thrust washer 77 relative to the collar 76. It will be appreciated that the thrust washer 77 reduces friction between the collar 76 and the cross-bar 73 upon extension and retraction of the linear actuator 20.

The bearing mount 71, which may also be referred to as a bearing mounting plate 71, fits matingly against the pillow block bearing 13 to enable securing the take-up device 11 thereto. The bearing mount 71 is secured to forward ends of the upper and lower prongs 74a and 74b and extends in a plane extending generally perpendicular to the planes in which the upper and lower prongs 74a and 74b respectively extend, with the bearing mount 71 oriented such that a central longitudinal axis of the linear actuator 20 extends through the center-point of the bearing mounting plate 71. The bearing mounting plate 71 extends from a first or upper end 80 to a second or lower end 81, and includes a first or upper receiving slot 85a and a second or lower fastener receiving slot 85b which are alignable with corresponding slots or features of the pillow block bearing 13 and are adapted to receive fasteners (not shown) such as screws, bolts, or the like, for securing the roller bracket 21 to the pillow block bearing 13.

The bearing mounting plate 71 and cross-bar 73, and the upper and lower prongs 74a and 74b, are respectively spaced apart from each other such that the access space 25 defined thereby can receive an adjustment tool (not shown) such as a ratcheting socket wrench, an Allen key, or a similar device for rotating the drive head 24 to drive the take-up device 11 between the retracted position and the extended position. It will be appreciated that the access space formed by the roller bracket 21 may be sized differently than the access space 25 shown and described herein, and that the access space 25 may comprise virtually any geometry appropriate for receiving an adjustment tool for rotating the drive head 24 of the take-up device 11.

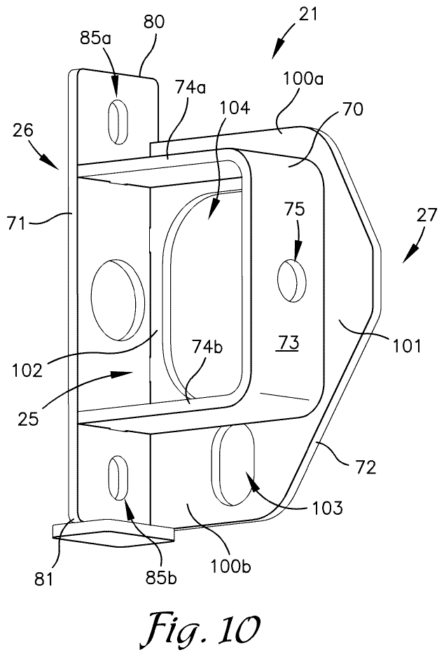

The backing plate 72 is secured to and extends between the yoke 70 and the bearing mounting plate 71 to provide structural support and increased rigidity to the roller bracket 21, thereby reinforcing the roller bracket 21 against bending, torsional, or shear forces imparted during use of the take-up device 11. As best shown in FIG. 10, the backing plate 72 is secured to an inner edge of the yoke 70 such that the backing plate 72 extends in a plane extending between the belt 19 of the conveyor 12 and the central longitudinal axis of the linear actuator 20. The support plate 72 has first and second arms 100a and 100b which are spaced apart from each other and extend forward from a rear cross-member 101 to opposing ends of a forward cross-member 102. The rear cross-member 101 extends along an inner edge of the yoke cross-bar 73, and the first and second arms 100a and 100b extend along inner edges of the upper and lower prongs 74a and 74b, respectively, such that the first and second arms 100a and 100b may be referred to as upper and lower arms 100a and 100b. The lower arm 100b is wider than the upper arm 100a, with the lower arm 100b including a support feature 103 configured to bear a wiping mechanism, commonly referred to as a “return plow,” for dislodging and removing residual ballast and other materials from the conveyor belt 19 between the feed and return runs. The support feature 103 of the embodiment shown is an aperture 103 formed in the backing plate 72 below the plane in which the lower prong 74b of the yoke 70 extends, with the aperture 103 sized to receive a corresponding feature of the return plow (not shown), such that the aperture 103 may be referred to as a return plow receiving aperture 103. The spaced apart arms 100b and 100b, the rear cross-member 101, and the front cross-member 102 cooperate to define an access opening 104 through which an adjustment tool may pass to enter the access space 25 and rotate the drive head 24. It should be understood that the access opening 104 may comprise virtually any geometry appropriate for receiving an adjustment tool for rotating the drive head 24 of the take-up device 11.

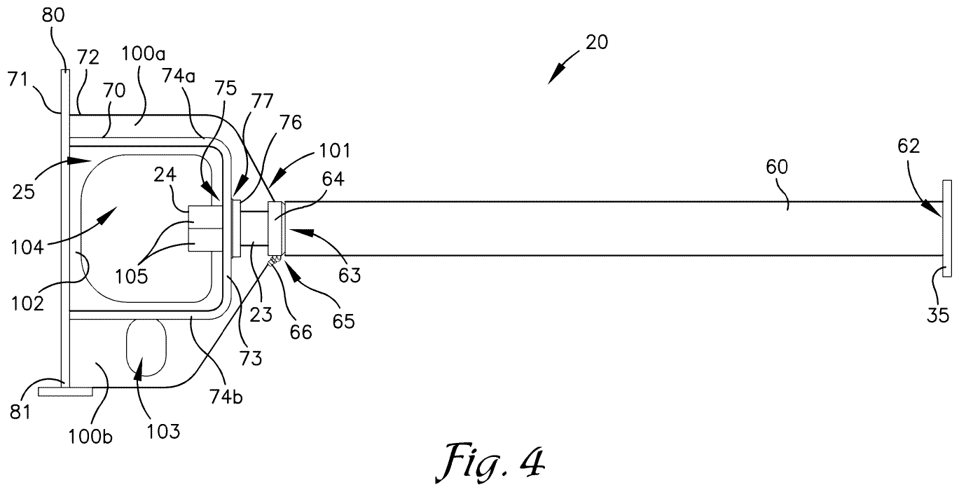

Referring now to FIGS. 4, 5, and 8, the rotatable drive head 24 is secured to the drive screw 23 such that the drive head 24 extends in closely spaced relation to the cross-bar 73 proximate the shaft opening 75, extending forward from the drive end 22 of the linear actuator 20 into the access space 25. The drive head 24 shown and described herein isa hex nut including a plurality of flats 105 for engagement with an adjustment tool to rotate the drive head 24 in a clockwise or counterclockwise direction, with rotation of the drive head 24 forcing corresponding rotation of the drive shaft 23 such that the threads formed on the drive screw 23 engage the threads formed in the threaded nut 64 to extend and retract the linear actuator 20. It is foreseen that the drive head 24 may be of various geometries and may include features such as slots or countersinks for engagement with different types of adjustment tools. It is also foreseen that the drive head 24 may include one or more wingnuts, wheels, cranks, or like mechanisms that are engageable for rotation by hand, and that the drive head 24 may comprise an electric motor or other means of electromechanical rotation.

Operation of the take-up device 11 is now described in accordance with an embodiment of the invention wherein first and second take-up devices 11a and 11b are used with the conveyor 12. An adjustment tool is used to rotate the drive heads 24 of each take-up device 11a, 11b, driving the take-up devices 11 to their retracted positions. Fasteners are extended through the fastener receiving holes 51 of each take-up device 11a, 11b to secure the left-side take-up device 11a to the left side of the conveyor 12 and the right-side take-up device 11b to the right side of the conveyor 12. Additional fasteners are extended through the first and second fastener receiving slots 85a, 85b formed in the bearing mounts 71 of each take-up device 11a, 11b to secure the take-up devices 11a, 11b to their respective pillow block bearings 13. With the take-up devices 11 secured to the conveyor 12 proximate the discharge end 16 thereof, the adjustment tool is used to rotate the drive heads 24 of each take-up device 11a, 11b, thereby extending each linear actuator 20 until the head roller 14 of the conveyor 12 is positioned such that the belt 19 is tensioned to prevent slippage or sagging thereof.

Upon tensioning of the belt 19, the conveyor 12 is continually or repeatedly operated to deposit ballast or other materials until repeated subjection to tension and load forces causes the belt 19 to elongate and slacken. The adjustment tool is periodically used to rotate the drive heads 24 of the take-up devices 11a and 11b, thereby re-positioning the head roller 14 and maintaining proper tension in the belt 19. When replacement of a belt 19 is desired, as may occur when repeated use and subjection to the loads of ballast or other materials transported by the belt 19 cause the belt to gradually elongate and slacken over time, the drive heads 24 of the take-up devices 11a and 11b may be rotated to drive the linear actuators 20 such that the take-up devices 11a and 11b advance from their extended positions toward the retracted positions. With the take-up devices 11a and 11b in their retracted positions, the slackened belt 19 may be replaced with a new belt 19, at which point the process described above is repeated over the lifespan of the replacement belt 19.

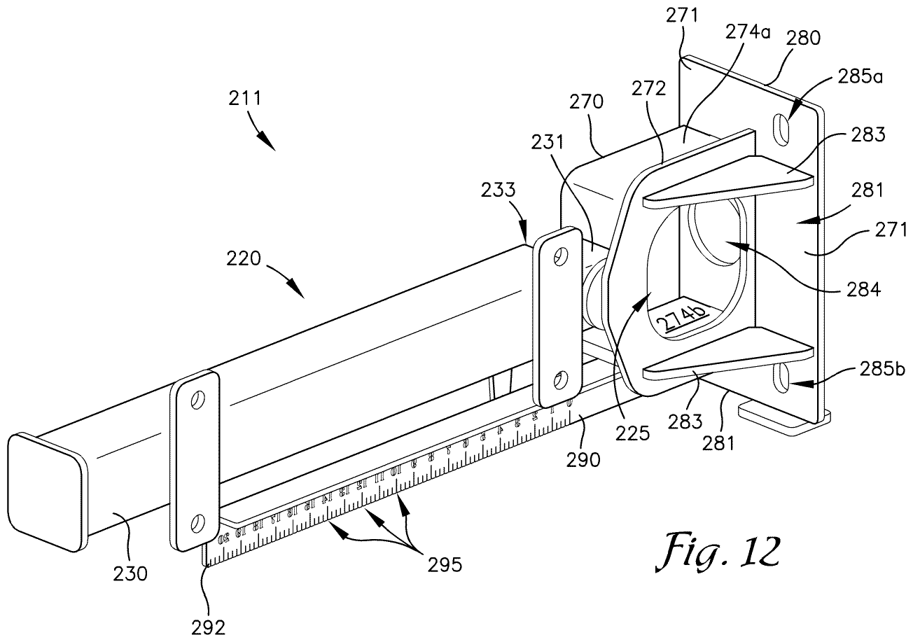

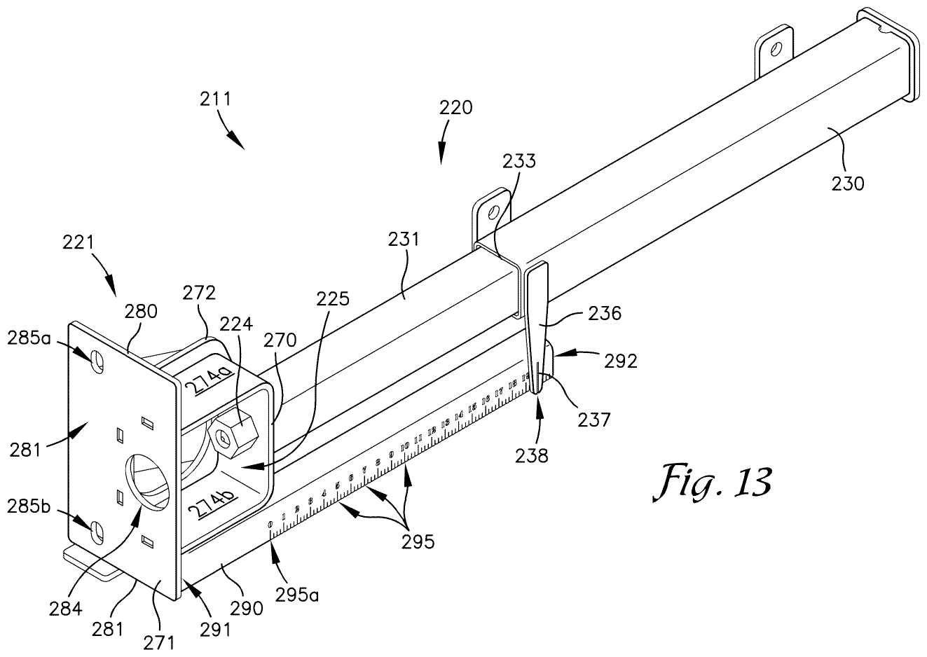

FIGS. 11-13 depict an alternative embodiment of the take-up device, which is denominated herein as take-up device 211 and includes a linear actuator 220 and a roller bracket 221. The linear actuator 220 and the roller bracket 221 generally include the same features as the linear actuator 20 and the roller bracket 21 described above. For example, like the linear actuator 20, the linear actuator 220 has a drive screw 223 with a drive feature 224 rotatably mounted thereto which extends into an access space 225 formed in the roller bracket 221, and the access space 225 is sized to receive tooling for adjusting the drive feature 224 to drive the take-up device between a retracted position (see FIG. 11) and an extended position (see FIG. 13). The linear actuator 220 further comprises an outer tube 230 and an inner tube 231 which extend in telescoping relationship to each other, and is mounted to the conveyor 12 in the same manner as the linear actuator 20.

An indicator or indicator plate 236 is secured to an outer wall of the outer tube 230 proximate the open front end 233 thereof, with the indicator plate 236 extending downward to a distal end 237 on which an indicating feature 238 is formed. The indicating feature 238 of the embodiment shown is an indicating slit 238 extending upward into the indicator plate 236 from the distal end 237. The indicator plate 236 and the indicating feature 238 thereof are positioned for cooperation with the hash or tick mark of a ruler, as will be described in greater detail below.

The roller bracket 221 extends between the actuator 220 and the pillow block bearing 13 and, like the roller bracket 21, includes a yoke 270, a bearing mount 271, and a backing plate 272 which are connected to each other and define the access space 225. The bearing mount 271, which may be referred to as a bearing mounting plate 271, is secured to forward ends of upper and lower prongs 274a and 274b of the yoke 271 and extends from an upper end 280 to a lower end 281. The bearing mount 271 extends inward beyond the plane in which the backing plate 272 extends to form an offset portion 282 in which upper and lower receiving slots 285a and 285b are formed, with a pair of gusset plates 283 extending between the offset portion 282 and the backing plate 272 to reinforce the bearing mount 271. The upper and lower receiving slots 285a and 285b are configured to receive fasteners or other attachment means for securing the pillow block bearing 13 to the offset portion 282 of the roller bracket 221. It will be appreciated that securement of the pillow block bearing 13 to the offset portion 282 spaces the pillow block bearing 13 away from an access opening 284 formed in the bearing mount 271, with the access opening 284 enabling tooling, such as an impact wrench equipped with an extension, to pass therethrough for engagement with the drive head 224 to drive the take-up device 211 between the extended position and the retracted position.

The take-up device 211 includes a slide ruler 290 which extends from a first or forward end 291 to a second or rearward end 292, with the forward end 291 of the slide 290 secured to a rear face of the bearing mounting plate 271 proximate the lower end 281 thereof. The slide ruler 290 extends rearward from the bearing mounting plate 271, extending beneath the lower yoke prong 274b and just inward of the indicator plate 236 such that the slide ruler 290 and the distal end 237 of the indicator plate 236 extend in closely spaced relation to each other. The slide ruler 290 extends a length corresponding to the stroke length of the linear actuator 220, and/or the maximum linear distance that the inner tube 231 slides into and out of the outer tube 230 as the take-up device 211 is driven between the retracted position and the extended position.

A plurality of hash marks or tick marks 295 which correspond to units of measurement (e.g., inches, centimeters, or the like) are formed on the slide ruler 290, with the hash marks 295 visible through the indicating slit 238 to enable identification of the position of the head roller 14 of the conveyor as the take-up device 211 is driven between the extended position and the retracted position. The hash marks 295 indicate a measured distance range extending from a first limit corresponding to the position of the head roller 14 when the take-up device 211 is in the retracted position to a second limit corresponding to the position of the head roller 14 when the take-up device 211 is in the extended position, with the hash marks 295 representing successive incremental increases in distance. In the embodiment shown, the first limit of the distance range indicated by the hash marks 295 is defined by a “zero” hash mark 295a which extends generally coplanar with the plane in which the open front end 233 of the outer tube 230 extends, and the second limit of the distance range indicated by the hash marks 295 is defined by the rearward end 292 of the slide ruler 290. It should be understood that the range of distance indicated by the hash marks 295 formed on the slide ruler 290 may be a greater or lesser range than the range shown and described herein, corresponding to take-up devices having a greater or lesser range of extension or retraction than the take-up device 211.

In use, a pair of take-up devices 211 support the head roller 14 of the conveyor 12. Prior to installation, an adjustment tool is advanced into the access space 225 of each take-up device 211 and rotatably engaged with the drive head 224 thereof to drive the take-up devices 211 to their respective retracted positions. Once retracted, the take-up devices 211 are secured to opposite sides of the conveyor 12 and to respective pillow block bearings 28 in a manner similar to that described above with respect to the take-up device 11. Upon securement of the take-up devices 211 proximate the discharge end 16 of the conveyor 12, an adjustment tool (e.g., an impact wrench equipped with an extension) is advanced into the access space 225, preferably via advancement through the access opening 284, and used to rotate the drive heads 224, extending the linear actuators 220 to advance the take-up devices 211 toward their extended positions until the head roller 14 is located such that the conveyor belt 19 is properly tensioned to prevent slipping, sagging, and other undesirable belt movement. As each take-up device 211 advances from the retracted position to the extended position, the indicating slit 238 of each indicator plate 236 cooperates with the hash marks 295 of the corresponding slide ruler 290 to display the instantaneous position of the head roller 14 as tension is applied to the belt 19.

With the belt 19 initially tensioned, the conveyor 12 may be operated continuously or intermittently to deposit ballast or other materials as needed. Over time, repeated loading causes the conveyor belt 19 to elongate and slacken, necessitating periodic re-tensioning. The take-up devices 211 enable such re-tensioning by allowing an operator to advance an adjustment tool into the access space 225 of each roller support bracket 221 (and preferably through the access opening 284 formed therein), with the adjustment tool rotating the drive heads 224 to drive the take-up devices 211 further toward their extended positions, thereby re-positioning the head roller 14 and restoring proper tension to the belt 19. It will be understood that as the take-up devices 211 are extended, the hash marks 295 visible through the indicating slit 238 provide real-time feedback on the position of the head roller 14, allowing the operator to monitor and record tensioning adjustment of the take-up devices 211, maintain symmetric extension of the take-up devices 211, and ensure consistent tracking of the belt 19. When replacement of the belt 19 is desired, the drive heads 224 are rotated to retract the linear actuators 220. Thereby advancing each take-up device 211 from its extended position toward its retracted position until sufficient slack is introduced into the belt 19 to permit removal and replacement thereof, after which the installation and tensioning sequence described above may be repeated for the new belt.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of this disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

As used in the claims, identification of an element with an indefinite article “a” or “an” or the phrase “at least one” is intended to cover any device assembly including one or more of the elements at issue. Similarly, references to first and second elements, or to a pair of elements, is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

What is claimed is:

1. A take-up device comprising:
a linear actuator comprising a rotary drive mechanism and a drive head, the drive head mounted to a drive end of the linear actuator; and
a roller bracket secured to the linear actuator, the roller bracket extending proximate the drive head;
wherein the drive head is rotatable to extend and retract the linear actuator.

2. The take-up device as in claim 1, wherein the linear actuator further comprises a nut threadingly coupled to the rotary drive mechanism.

3. The take-up device as in claim 1, wherein the rotary drive mechanism is a drive screw.

4. The take-up device as in claim 1, wherein an access space is formed in the roller bracket.

5. The take-up device as in claim 4, wherein the drive head extends through an opening formed in the roller bracket and into the access space.

6. The take-up device as in claim 5, wherein the access space is sized to receive an adjustment tool to rotate the drive head.

7. The take-up device as in claim 4, the roller bracket comprising a yoke and a bearing mount secured to each other and cooperating to define the access space.

8. The take-up device as in claim 7, the yoke comprising a cross-bar extending proximate the drive end of the linear actuator and first and second prongs, the first and second prongs extending forward from the cross-bar to the bearing mount and spaced apart from each other such that the access space extends therebetween.

9. The take-up device as in claim 8, the linear actuator further comprising a thrust washer circumscribing the rotary drive mechanism, the thrust washer abutting against the cross-bar of the roller bracket.

10. A conveyor take-up device comprising:
a roller bracket securable to a head roller of a conveyor;
a linear actuator extending between a frame of the conveyor and the roller bracket, the linear actuator comprising a drive screw extending within at least one tube;
a drive head mounted to a drive end of the linear actuator and rotatable to extend and retract the drive screw; and
an access space formed within the roller bracket and into which the drive head extends.

11. The conveyor take-up device as in claim 10, wherein the at least one tube is an outer tube and an inner tube extending in telescoping relationship with each other.

12. The conveyor take-up device as in claim 10, further comprising an indicator plate secured to the linear actuator, the indicator plate having an indicating slit formed therein.

13. The conveyor take-up device as in claim 12, further comprising a slide ruler secured to the roller bracket, the slide ruler extending a distance corresponding to a stroke length of the linear actuator.

14. The conveyor take-up device as in claim 13, wherein the slide ruler comprises a plurality of hash marks, the slide ruler oriented such that a selective one of the plurality of hash marks is visible through the indicating slit.

15. The conveyor take-up device as in claim 10, wherein the roller bracket comprises a yoke, a bearing mount, and a backing plate secured to each other and cooperating to define the access space.

16. The conveyor take-up device as in claim 15, wherein the bearing mount extends beyond a plane in which the backing plate extends to form an offset portion.

17. The conveyor take-up device as in claim 16, further comprising a gusset plate extending between the offset portion and the backing plate.

18. The conveyor take-up device as in claim 16, wherein an access opening is formed in the bearing mount, the access opening sized to allow an adjustment tool to pass therethrough for engagement with the drive head.

19. A method of maintaining tension of a conveyor belt with a conveyor take-up device, the method comprising:
securing a roller bracket of the conveyor take-up device to a bearing supporting a head roller of a conveyor, and securing a linear actuator of the conveyor take-up device to a frame of the conveyor, the linear actuator comprising a drive screw threadingly engaged with a threaded nut and a drive head at a drive end of the linear actuator;
advancing an adjustment tool into an access space formed in the roller bracket and rotatably engaging the adjustment tool with the drive head; and
rotating the drive head with the adjustment tool to rotate the drive screw relative to the threaded nut, thereby translating the drive screw to extend the linear actuator and move the head roller relative to the frame.
